(19) United States
(12) Patent Application Publication
(10) Pub. No.: US 2022/0300656 A1
(43) Pub. Date: Sep. 22, 2022

(54) ELASTIC ENCLAVES FOR SECURITY OBJECT MANAGEMENT

(71) Applicant: Fornetix LLC, Frederick, MD (US)

(72) Inventors: Charles White, Charles Town, WV (US); Gerald Stueve, Herndon, VA (US)

(21) Appl. No.: 17/695,695

(22) Filed: Mar. 15, 2022

Related U.S. Application Data
(60) Provisional application No. 63/163,170, filed on Mar. 19, 2021.

(51) Int. Cl. G06F 21/62; G06F 21/60; G06F 21/57; G06F 21/44

(52) U.S. Cl. CPC G06F 21/6281; G06F 21/6227; G06F 21/602; G06F 21/572; G06F 21/44

(57) ABSTRACT

Methods are described herein for associating one or more first systems with one or more second systems, where the first system has a first cryptographic boundary and the second system has a second cryptographic boundary, identifying, at the one or more first systems, one or more security objects on one or more second systems in the second cryptographic boundary, performing one or more security functions at the one or more first systems using the one or more security objects, the performance of the security function occurring in the first cryptographic boundary, and transmitting, by the one or more first systems, one or more results based on the performed one or more security functions.

### CROSS-REFERENCE TO RELATED APPLICATION

The present application claims the benefit of U.S. Provisional Application No. 63/163,170, filed Mar. 19, 2021, the content of which are fully incorporated herein by reference in its entirety. The present disclosure relates to U.S. application Ser. No. 16/933,309, filed Jul. 20, 2020, which is a continuation of U.S. application Ser. No. 16/374,522, filed Apr. 3, 2019, which is now U.S. Pat. No. 10,742,689, granted Aug. 11, 2020, which is a continuation of U.S. application Ser. No. 15/662,185, filed Jul. 27, 2017, which is now U.S. Pat. No. 10,257,230, granted Apr. 9, 2019, which is a continuation of U.S. application Ser. No. 14/506,346, filed Oct. 3, 2014, which now U.S. Pat. No. 9,729,577, granted Aug. 8, 2017, which claims priority from U.S. Provisional Application No. 61/887,662, filed Oct. 7, 2013, and U.S. Provisional Application No. 61/950,362, filed Mar. 10, 2014, each of which is incorporated herein by reference in its entirety. The present disclosure also relates to U.S. application Ser. No. 15/954,280, filed Apr. 16, 2018, which is now U.S. Pat. No. 10,567,355, granted Feb. 18, 2020, which is a divisional of U.S. application Ser. No. 15/067,035, filed Mar. 10, 2016, which is now U.S. Pat. No. 10,560,440, granted Feb. 11, 2020, which claims priority from U.S. provisional Application No. 62/132,342, filed Mar. 12, 2015, each of which is incorporated herein by reference in its entirety. The present disclosure also relates to U.S. application Ser. No. 16/820,517, filed Mar. 16, 2020, which is a continuation of U.S. application Ser. No. 15/067,074, filed Mar. 10, 2016, which is now U.S. Pat. No. 10,630,686, granted Apr. 21, 2020, which claims priority from U.S. provisional Application No. of 62/132,372, filed Mar. 12, 2015, each of which is incorporated herein by reference in its entirety. The present disclosure also relates to U.S. application Ser. No. 15/067,814, filed Mar. 11, 2016, which is now U.S. Pat. No. 9,967,289, granted May 8, 2018, which claims priority from U.S. Provisional Application No. 62/132,379, filed Mar. 12, 2015, each of which is incorporated herein by reference in its entirety. The present disclosure also relates to U.S. application Ser. No. 15/067,084, filed Mar. 10, 2016, which claims priority from U.S. Provisional Application No. 62/133,172, filed Mar. 13, 2015, each of which is incorporated herein by reference in its entirety. The present disclosure also relates to U.S. application Ser. No. 15/269,310, filed Sep. 19, 2016, which is now U.S. Pat. No. 10,257,175, granted Apr. 9, 2019, which claims priority from U.S. Provisional Application No. 62/233,900, filed Sep. 28, 2015, each of which is incorporated herein by reference in its entirety. The present disclosure also relates to U.S. application Ser. No. 15/439,077, filed Feb. 22, 2017, which claims priority from U.S. Provisional Application No. 62/300,352, filed Feb. 26, 2016, each of which is incorporated herein by reference in its entirety. The present disclosure also relates to U.S. application Ser. No. 15/439,455, filed Feb. 22, 2017, which claims priority from U.S. Provisional Application No. 62/300,521, filed Feb. 26, 2016, each of which is incorporated herein by reference in its entirety. The present disclosure also relates to U.S. application Ser. No. 15/439,781, filed Feb. 22, 2017, which claims priority from U.S. provisional Application No. 62/300,670, filed Feb. 25, 2016, each of which is incorporated herein by reference in its entirety. The present disclosure also relates to U.S. application Ser. No. 15/439,839, filed Feb. 22, 2017, which is now U.S. Pat. No. 10,348,485, granted Jul. 9, 2019, which claims priority from U.S. Provisional Application No. 62/300,687, filed Feb. 26, 2016, each of which is incorporated herein by reference in its entirety. The present disclosure also relates to U.S. application Ser. No. 15/439,861, filed Feb. 22, 2017, which claims priority from U.S. provisional Application No. 62/300,699, filed Feb. 26, 2016, each of which is incorporated herein by reference in its entirety. The present disclosure also relates to U.S. application Ser. No. 15/439,873, filed Feb. 22, 2017, which claims priority to U.S. Provisional Application No. 62/300,717, filed Feb. 26, 2016, each of which is incorporated herein by reference in its entirety. The present disclosure also relates to U.S. application Ser. No. 15/880,794, filed Jan. 26, 2018, which is now U.S. Pat. No. 10,713,077, granted Jul. 14, 2020, which claims priority from U.S. patent provisional Application No. 62/450,984, filed Jan. 26, 2017, each of which is incorporated herein by reference in its entirety.

### BACKGROUND

Extending the computing capabilities of physical devices can be accomplished by implementing remote computing. For example, cloud services can be used to increase the operations performed by an on-premises computer (computers or other devices located on or in the premises of a person or organization, or the like). In some contexts, the capabilities of on-premises devices can be scaled up by adding virtual processors that collaborate with on-premises devices. However, device interaction can be limited by data security, confidentiality and integrity protocols.

Traditionally, the Federal Information Processing Standard (FIPS) defines a cryptographic boundary as a physical boundary that contains all of the software and/or hardware used to store, protect and generate cryptographic information. The cryptographic boundary may be a limited area where the highest security protocols are observed such that the area within the cryptographic boundary remains controlled. A narrowly defined cryptographic boundary strengthens the security of the cryptography implemented in the cryptographic boundary. However, a narrowly defined cryptographic boundary also limits the cryptographic support that remote systems can provide for on-premises systems. Thus, there is a need to extend support to on-premises devices without extending the scope of the cryptographic boundary.

### SUMMARY

The example arrangements disclosed herein are directed to solving the issues relating to one or more of the problems presented in conventional cryptographic boundaries, as well as providing additional features that will become readily apparent by reference to the following detailed description when taken in conjunction with the accompanying drawings. In accordance with various arrangement, example methods and computer program products are disclosed herein. It is understood however, that these arrangements are presented by way of example and are not limited, and it will be apparent to hose or ordinary skill in the art who read the present disclosure that various modifications to the disclosed arrangements can be made while remaining within the scope of this disclosure.

In some arrangements, a method of using security objects across cryptographic boundaries includes associating one or more first systems with one or more second systems, where the first system has a first cryptographic boundary and the second system has a second cryptographic boundary, identifying, at the one or more first systems, one or more security objects on one or more second systems in the second cryptographic boundary, and performing one or more security functions at the one or more first systems using the one or more security objects, the performance of the security function occurring in the first cryptographic boundary.

The above and other aspects and their implementations are described in greater detail in the drawings, the descriptions, and the claims.

### BRIEF DESCRIPTION OF THE DRAWINGS

The accompanying drawings, which are incorporated herein and constitute part of this specification, illustrate exemplary arrangements of the disclosure, and together with the general description given above and the detailed description given below, serve to explain the features of the various arrangements.

FIG. 1 is a schematic diagram of an example system of cloud-based support of on-premises devices, according to some arrangements.

FIG. 2 is a generalized diagram of a cryptographic system according to some arrangements.

FIG. 3 is a schematic diagram of an enclave provisioning system according to some arrangements.

FIG. 4 is a schematic diagram showing an example system of enclave and on-premises device continuity, according to some arrangements.

FIG. 5 is a flow chart of a method of using security objects across cryptographic boundaries, according to some arrangements.

FIG. 6 is a flow chart of a method of identifying security objects, according to some arrangements.

FIG. 7 is schematic diagram showing an example system of support provided for an on-premises device by an enclave, according to some arrangements.

### DETAILED DESCRIPTION

Various arrangements will be described in detail with reference to the accompanying drawings. Wherever possible, the same reference numbers can be used throughout the drawings to refer to the same or like parts. Different reference numbers can be used to refer to different, same, or similar parts. References made to particular arrangements and implementations are for illustrative purposes, and are not intended to limit the scope of the disclosure or the claims.

Cloud service providers can be entities that provide a network of one or more remotely accessible servers. These cloud-based systems, as described herein, can further extend the capabilities of on-premises systems. For example, a cloud-based system can extend the capability of on-premises systems by allowing on-premises systems to access applications remotely. Similarly, a cloud-based system can extend the capability of on-premises systems by allowing the on-premises systems to access stored data remotely. Further, a cloud-based system can extend the capability of on-premises systems by effectively loaning processing power, in the form of virtually accessible processors, to on-premises devices. Examples of cloud service providers include Amazon, Azure, and Google. On-premises systems can include one or more individual computers or other communication devices, on-site networks of multiple computers or other communication devices, data centers having a network of physically configured servers, or the like.

In some arrangements, one or more on-premises systems can be supported by a cloud-based system. Alternatively, an on-premises system can be supported by multiple cloud-based systems. Further, one cloud-based system can support multiple on-premises systems.

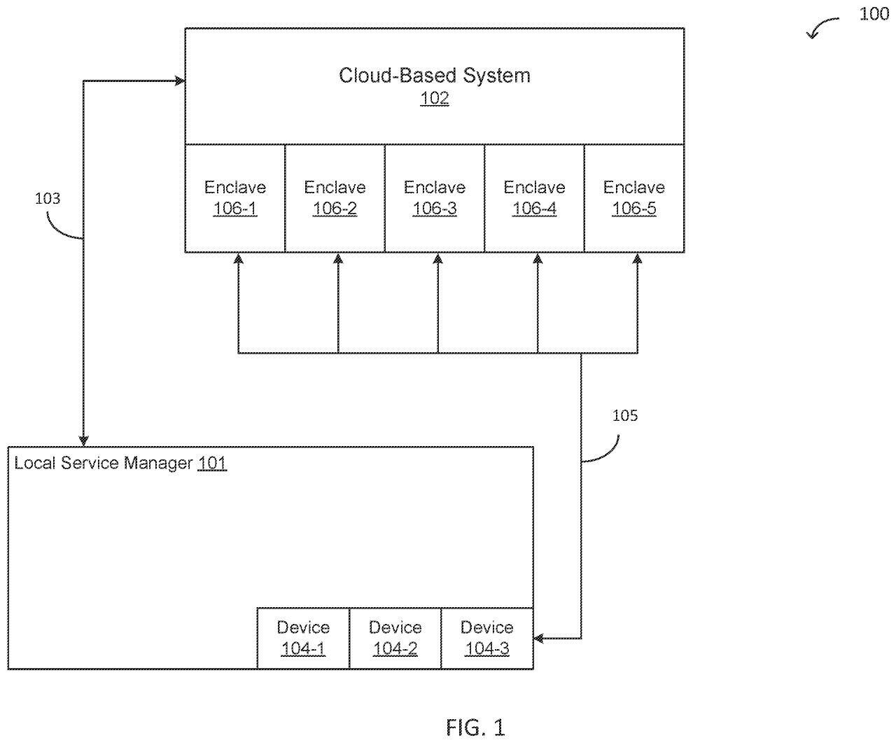

FIG. 1 is a schematic diagram of an example system 100 of cloud-based support of on-premises devices, according to some arrangements. The example system 100 in FIG. 1 includes a local service manager 101, local devices 104 (e.g., 104-1 to 104-3), a cloud-based system 102 and enclaves 106 (e.g., 106-1 to 106-5). In particular examples, the components of the example system 100 can be implemented virtually (through software running on one or more processing systems) or physically (as separate processing devices or systems), or combinations thereof.

The cloud-based system 102 may be hosted by a cloud service provider. The cloud-based system 102 may provision one or more enclaves 106 (e.g., 106-1 to 106-5), where an enclave 106 can be a self-sustaining portion of the larger (or complete) cloud-based system. An enclave 106 may be provisioned by, such as, but not limited to those methods described in U.S. Patent Application No. 62/450,984 (which is incorporated herein by reference, in its entirety) or by any other application incorporated by reference in the Cross-Reference to Related Application section. An example of a method of provisioning an enclave using a cloud-based system will be discussed herein. It should be appreciated that cloud-based systems, enclaves provisioned from cloud-based systems or other virtual environments can be used interchangeably throughout the present disclosure.

The local service manager 101 can manage one or more devices 104 (e.g., 104-1 to 104-3). In some arrangements, devices 104 can be independent devices managed by local service manager 101. In alternate arrangements, devices 104 can be one or more subsystems that can be part of a larger system that is managed by local device manager 101. It should be appreciated that local devices and on-premises systems can be used interchangeably throughout the present disclosure.

The cloud-based system 102 can communicate management information with the local service manager 101. For example, administrative and/or management information can be communicated between the cloud-based system 102 and the local service manager 101 via path 103. Management information sent from the cloud-based system 102 can include, but is not limited to, a request to audit and/or monitor the devices 104 of the local service manager 101. Management information sent from the local service manager 101 can include, but is not limited to authorization or rejection of the audit and/or monitor request sent from the cloud-based system 102.

Each of the enclaves 106 can be associated with a local device 104. In some arrangements, each of the enclaves 106 are associated with local devices 104 in response to receiving approval from the local service manager 101 or other authorization from a similar managing body. In some examples, enclave 106-1 can be associated with local device 104-1, enclave 106-2 can be associated with device 104-2, and the like. In other examples, enclave 106-1 can be associated with local device 104-1 and 104-2. Thus, enclaves may be associated with one or more local devices as shown via path 105. The association of the cloud-based enclaves 106 and the local devices 104 can facilitate identification of security objects stored and/or located on the local device 104.

Security objects may include encryption keys and other sensitive objects (such as, but not limited to, user identity information, certificates, biometric data, random number generator data, determinate random number generator data, non-determinate random number generator data, user authentication information, policy information, other policy components associated with organization security component, automation information, device data, audit data and/or the like). In some examples, policy information can include security metadata that defines the operational life cycle and/or restrictions on uses of security objects. In some examples, the operational life cycle, crypto period and/or restrictions on uses of the security objects can be contained within the security object. The operational life cycle can be determined by the sensitivity of the data that the security object is aiming to protect, the amount of data being protected, the number of security objects protecting the data, and the like.

In some arrangements, a security object may be activated immediately upon creation. In alternate arrangements, the security can be activated for use at a later point in time. In one example, security objects can be activated automatically in the event of a triggering event, or manually. In particular examples, a triggering event can include a security object being assigned to a device.

In some arrangements, security objects including automation information can include scripting and job scheduling for operations to be executed on the cloud-based enclave. In some arrangements device data can include identity or credentials of devices authorized to connect to the cloud-based enclaves. In some arrangements, the audit data can include data on the on-premises device. In particular examples, the data from the transaction audit that triggered the replication of the security objects can be replicated as a security object.

Security objects can further be or include any other security object described in other applications incorporated by reference in the Cross-Reference to Related Application section. In the present disclosure, keys such as cryptographic (encryption and/or decryption) keys are described in various examples as examples of security objects. It should be appreciated that other security objects, including those described above, may be employed in examples described herein, instead of cryptographic keys. In particular examples, a security object as described above can include or be formed of digital data, instructions or information that can be communicated on a communication network, stored in a non-transitory electronic memory and/or processed in an electronic processor.

As explained herein, each cloud-based enclave and/or system can have its own confidentiality and integrity protocols. For example, each enclave 106 can have restricted access and restricted sharing protocols. Further, each enclave 106 can have or be associated with a cryptographic boundary separate from the cryptographic boundaries of each other enclaves 106 and/or cloud-based system. Similarly, each local device 104 and/or on-premises system can have its own cryptographic boundary separate from each other on-premises system.

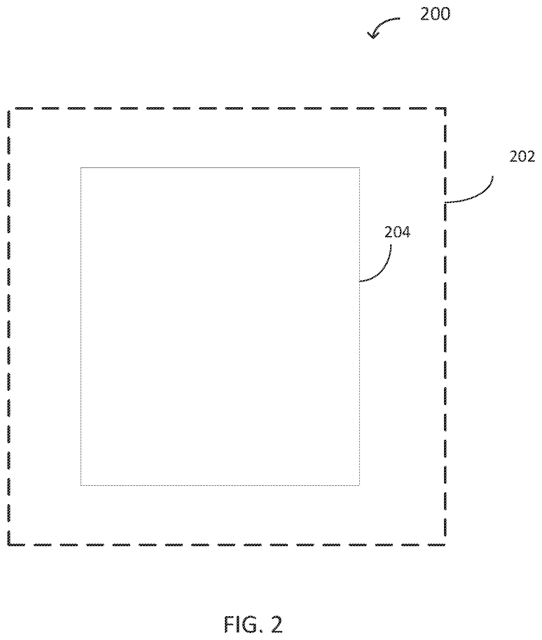

FIG. 2 is a generalized diagram representing a cryptographic system 200 having a cryptographic boundary 202. The cryptographic system 200 may represent an on-premises system, or an enclave of a cloud-based system as described herein. The cryptographic boundary 202 encompasses a device and/or platform 204 (or multiple devices and/or platforms represented by 204). In some arrangements, the device 204 can be a circuit chip (or multiple chips), and may contain several sub-chips. In some arrangements, the device 204 can be a communication device such as a mobile phone, a desktop, a laptop, a server, a router, and the like (or a plurality or combination of such communication devices). In some arrangements, the platform 204 can be where the software, firmware and/or operating system of the device 204 reside. Examples of operating systems can include, but are not limited to Microsoft Windows, Apple OS, Linux or UNIX. In particular examples, all of the cryptographic functions for device and/or platform 204 occur within the cryptographic boundary 202.

To comply with certain industry or regulatory definitions of cryptographic boundaries, each cryptographic system must be self-contained. Seamless support of on-premises systems by extending the security mechanisms from enclaves to other enclaves, and/or from enclaves to on-premises systems may involve data replication. The replication of security mechanisms across cryptographic boundaries provides for continuity between on-premises systems and cloud-based systems, allowing the on-premises systems and cloud-based systems to behave as one enclave.

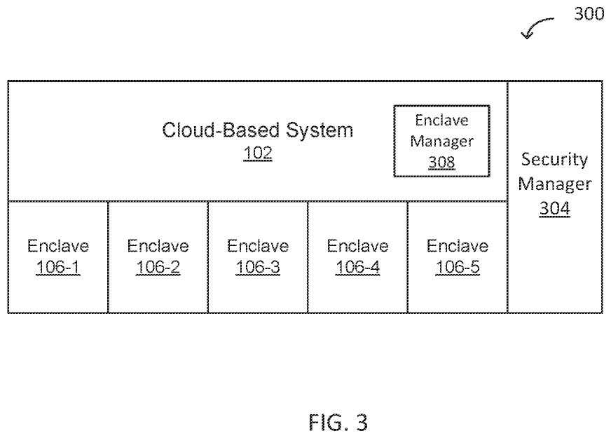

FIG. 3 is a diagram of an enclave provisioning system 300, according to some arrangements. Enclave provisioning may be performed according to, but not limited by, those methods described in U.S. Patent Application No. 62/450,984 (which is incorporated herein by reference, in its entirety) or by any other application incorporated by reference in the Cross-Reference to Related Application section. The enclave provisioning system 300 in FIG. 3 includes a cloud-based system 102 (or generally, a cloud service provider), a security manager 304, one or more (or a plurality of) enclaves 106 and an enclave manager 308. In particular arrangements, those components of the enclave provisioning system 300 can be implemented virtually (through software running on one or more processing systems) or physically (as separate processing devices or systems), or combinations thereof. A cloud service provider can host the cloud-based system 102. One or more aspects of enclave management can be provided at the cloud service provider. For example, enclaves 106 (e.g., 106-1 to 106-5) can be created by an enclave manager 108 at the cloud service provider 102. In some examples, the enclave manager 108 may be configured in the same computer or network system with the enclaves 106. In alternate examples, the enclave manager 108 can be operated or managed as or by a separate operator entity or system.

The availability of the cloud-based system's resources and the demand for cloud-based enclaves 106 can determine the provisioning of enclaves 106 needed to support the on-premises systems. Secure replication and route replication traffic can consume network resources. Thus, the availability of system resources and the demand for the extension of remote encryption support can determine the provisioning of enclaves and the utilization of such enclaves as cloud-based support for on-premises systems. Each enclave 106 can run a set of applications within the limits of the computing, storage and networking resources available to that single enclave 106.

An enclave manager 308 can include one or more (or each) of a Secure Kernel Hypervisor (SKH), a Key Management System (KMS) and a Cloud Orchestration System (COS). In particular examples, the SKH, KMS and COS can be implemented to enable multiple enclaves in a multi-tenant cloud environment. In such examples, one cloud-based system 102 can be capable of supporting multiple enclaves, where the enclaves are capable of supporting multiple on-premises systems.

The SKH can run on any suitable processing hardware or software architecture including, but not limited to an Intel x86 or ARM v8 stack, to allow a COS (such as, but not limited to Cloud Stack, Open Stack, Amazon, Azure, HP Eucalyptus, Nebula) to subdivide a computer's hardware responsible for the cloud, partitioning the cloud into separate physical subjects. A separation kernel can be configured at installation time and resources including memory addressing can be setup. In certain examples, this approach subdivides a computer's hardware physically using the central processing unit's (CPU's) built-in hardware virtualization capabilities to partition the hardware responsible for the cloud into separate physical subjects. In certain examples, a hypervisor may be included in the system to virtualize the hardware to run (execute in) multiple different operating systems or applications.

In some examples, each of the partitioned subjects can become an enclave 106. The COS can manage the computing, storage and network components of the cloud and the various enclaves 106. In particular examples, the COS can use one or more algorithms which dynamically determine when and how much of each cloud resource and/or each cloud application is needed. The resources may include, but are not limited to one or more (or each) of CPU, network, storage, or other computing resources as well as peripherals. In certain examples, the COS is configured to assess the dynamically changing resource needs of the applications it is supporting, and to automatically allocate or de-allocate those resources in an elastic fashion.

The COS may coordinate with one or more (or each) of the Cloud Host Manager (CHM), Cloud Orchestration Agent (COA) and the Cloud Host Network Manager (CHNM) to allocate resources. In some examples, a single stack of hardware can be partitioned. In other examples, multiple stacks of hardware are partitioned.

In certain examples, the SKH can be integrated within a COS such as, but not limited to, “Apache Cloud Stack” or any other similar system of cloud management software to allow a single cloud environment (e.g., cloud-based system 102) to set up one or more (or multiple separate) “Virtual Work Package” (VWP). Multiple VWPs can be arranged to operate in a single domain of security, all running on a single set of computing, network, and storage hardware. For example, each enclave 106 can be associated with (or considered as) one or more VWPs. In particular examples, each enclave 106 is associated with a different one or more VWPs, with respect to each other enclave 106. Each VWP includes one or more client virtual machines, and may further include one or more (or each) of a key management coordinator (or client) which connects to the key management server, a disk encryption driver which encrypts content which is being stored to disk, and a network encryption driver which encrypts content being sent over the network (e.g. Internet Protocol Security or IPSec). The VWP may be built using a SKH and encryption. When the VWP is created, a series of encryption keys can be retrieved from the KMS and associated with the new VWP, which enables the new VWP. Once enabled, a VWP can take on a personality which means it can be allocated for virtual machines running specific operating systems or specialty applications running within each VWP. To destroy a VWP, the cloud orchestration system revokes the VWP resources and the associated encryption keys, and the VWP is rendered inoperable. Its resources can then be re-allocated to a new VWP.

In certain examples, the partitioning is made in a practical manner by using SKH technology and a KMS can manage the multiple encryption keys and/or other security objects needed to secure the network, storage and other encryption needed for cloud-based enclave environments.

Further, the KMS can support key management between the various VWPs. KMS is particularly useful in high volume environments where hundreds or thousands of VWPs are being managed along with their underlying virtual networking and storage encryption needs. The KMS makes it possible to manage day-to-day encryption key management needs in a highly secure, rapid manner with appropriate policy, documentation, logging and individual security. Implementing a COS using a SKH and KMS reduces the risk of information leakage between the separated enclaves in the cloud. For example, each enclave can have separated virtual networks.

Networks within a single cloud are separated using Virtual Private Networking (VPN) capabilities employing IPSec security protocols. To allow pre-determined network traffic (if any is allowed at all) to go between enclaves 106 (e.g., inter-enclave traffic from enclave 106-1 to enclave 106-2) a Guard must be deployed as part of the Trusted Computing Base (TCB). The Guard may be implemented in software programming or routines that only allow traffic to pass through, if the correct credentials and encryption keys are present to allow decrypt, filtering and encrypting of inter-enclave network traffic.

In certain arrangements, the security manager 304 can manage the enclaves 106. The security manager 304 can create policies in the enclaves 106 such that the enclaves 106 seamlessly interface with on-premises systems. In the present disclosure, a policy can be a rule managing the enclaves. It should be appreciated policies may manage enclaves based on need, security, user preferences, or the like. The policies described in the other applications incorporated by reference in the Cross-Reference to Related Application section may also be used to govern enclave management or other aspects of the present disclosure. In one arrangement, transaction auditing can be a policy implemented in enclaves 106 to support monitoring of on-premises systems.

Referring to FIGS. 1-4, the data replication system 400 is an example system of enclave and on-premises device continuity, according to some arrangements. As discussed herein, the cloud-based system 102 may have received approval to audit transactions by a local service manager 101, as shown by path 103. The on-premises device's (e.g., 104-1 to 104-3) demand for cloud-based system support can facilitate the enclave manager's 308 provisioning of enclaves 106-1 to 106-5. In particular examples, the on-premises system can be considered an authoritative device because the cloud-based system support may be scaled to meet the demands of the on-premises system. One or more security objects may be obtained by, or available on, each on-premises system for initial programming and registration. With those objects the on-premises system can perform security functions within its own cryptographic boundary. Security functions performed by the on-premises system can include data or message encryption, data or message decryption, firmware signing, firmware validation, attestation of device trust, generation of device specific machine authentication codes, or the like. Security functions may further include the security functions described by any other application incorporated by reference in the Cross-Reference to Related Application section.

Remote cloud-based systems can extend support, including security support, for the on-premises systems. Extending security support of on-premises systems through the implementation of cloud-based systems can include support of one or more (or each) of security functions including the security functions described herein. The cloud-based system can support the on-premises system by alleviating the on-premises system of one or more of those or other security support tasks.

The enclaves 106 may be configured by the security manager 304 with transaction auditing capabilities such that the enclaves are monitoring the transactions at the local devices 404, as represented by path 105. In some examples, the local devices 104 may be enclaves of a host server. The partitioning of the host server into enclaves may be performed as described herein or described according to any of the applications incorporated in the Cross-References to Related Applications section. Each enclave 106 can audit transactions of a different on-premises device 104 relative to each other enclave 106. For example, enclave 106-1 can audit the transactions of on-premises device 404-1. Similarly, enclave 106-2 can audit the transactions of on-premises device 402-2 and the like.

Transaction auditing may involve the enclaves 106 auditing and/or monitoring the transactions on the on-premises systems. In some arrangements, the on-premises devices may be audited based on queries received from other systems or entities, the queries audited based on certain transactions or keywords such as requests to encrypt and/or decrypt messages and/or data, firmware signing, firmware validation, attestation of device trust, generation of device specific authentication codes, or the like. For example, a local device (e.g., 104-1) in the on-premises system may receive a request from a third device (not shown) to encrypt a message. An enclave associated with the local device 104-1 (e.g., 106-1) may passively audit the local device 104-1. The enclave 104-1 auditing the local device 104-1 may recognize, based on passive auditing for example, that certain transactions are being performed or requested, or that certain keywords (such as, but not limited to, the keyword “encrypt”) was used in the message received by the local device 104-1. Alternatively or in addition, the enclaves may audit the on-premises systems such that the enclaves become aware of new security objects. In one example, an encryption key may be destroyed and/or generated based on the expiration of the operational life cycle of the encryption key. In the event that a new key is generated, the enclave may recognized, based on passive auditing, the generation of the new key. In other examples, the enclave may know (have information identifying) the operational life cycle of the encryption key and may be configured to audit the on-premises system at or upon the expiration of the encryption key, for example, to determine the new key that the on-premises system generates.

To enable such auditing, cloud-based system 102 can request transaction auditing approval from a local service manager 101 associated with an on-premises system. In one example, in the event a local device 104 performs a cryptographic transaction, the security object will be replicated (e.g., copied or received), based on the auditing, at the enclave 106 that is auditing the local device 404, as shown in path 406. For example, if local device 404-2 generates a key, the enclave auditing local device 404-2, for example 106-2, can replicate the key generated by the local device 404-2. The cryptographic transactions are the transactions audited by the cloud-based system that contain security object. Cryptographic transactions may include one or more (or each) of security object creation, security object activation, security object destruction, security object archival, machine authentication code generation, message encryption, message decryption, or the like.

Thus, the cryptographic boundary of the local devices 104 and the enclaves 106 remain the same size, while the security object (i.e., a key) is replicated such that enclave 106-2 is capable of decrypting a message with the key instead of device 104-2.

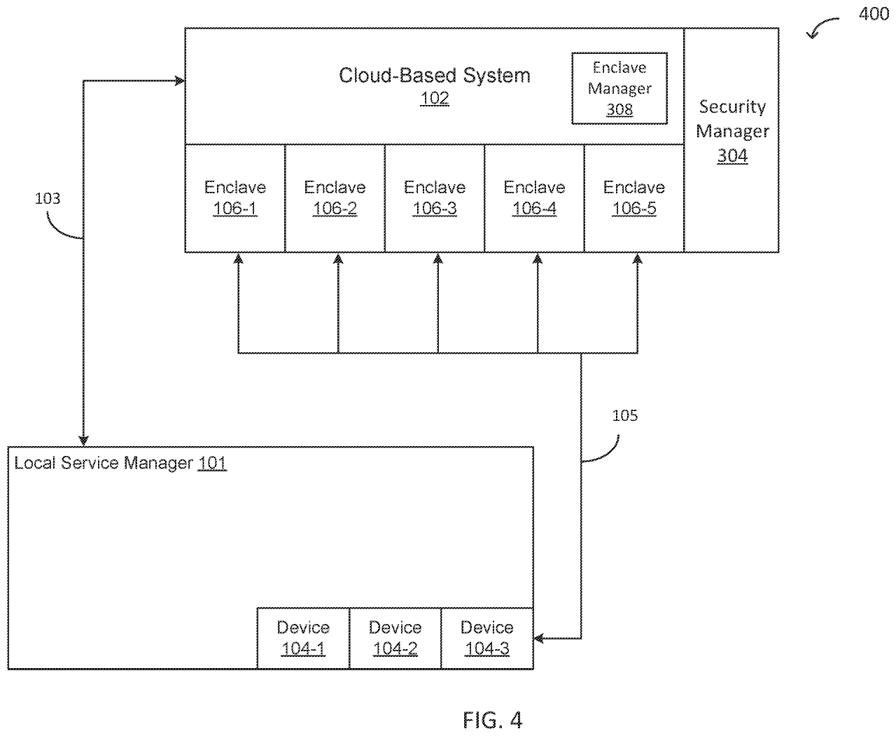

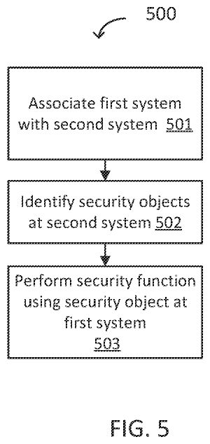

FIG. 5 is a flow chart of a method 500 of using security objects across cryptographic boundaries, according to some arrangements. As shown in block 501, a first system, (e.g., enclave 106 in FIG. 4 or other cloud-based system) may associate (or be associated) with a second system, (e.g., one or more local devices or other on-premises-devices 104 in FIG. 4). The first system and second systems may each have a cryptographic boundary.

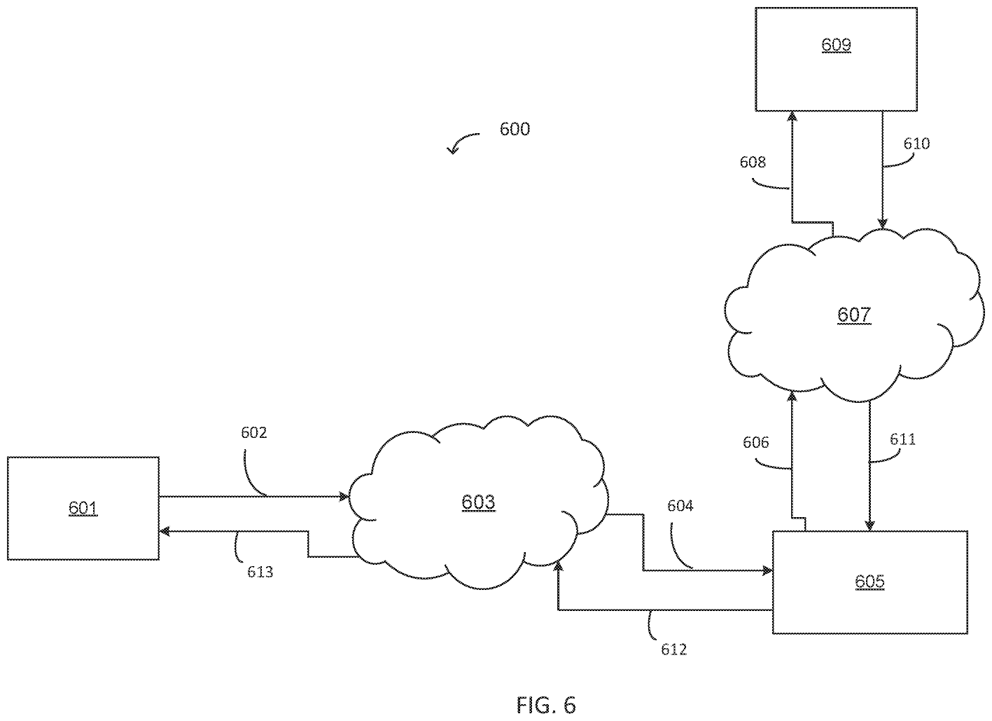

As shown in block 502, the first system may identify one or more security objects at the second system (for use by the second system). An example method for identifying security objects used by the second system is discussed herein, with reference to FIG. 6.

At block 503, the one or more security object may be used at the first system (e.g., enclave 106 in FIG. 4 or other cloud-based system). In one example, the security object may be used to perform a security function in addition to or in place of (e.g., to off-load) the performance of that security function by the second system. Thus, the first system may perform a security function using the replicated security object such that the security function performed at the first system is equivalent to the security function performed (or that would have been performed) at the second system (e.g., local device or other on-premises-device 104 in FIG. 4).

At block 504, the result of the security function may be transmitted to a device (for example, on-premises systems and/or local devices 104, where the on-premises systems and/or local devices 104-1, 104-2, 104-3 are associated with enclaves and/or cloud based systems 106-1, 106-2, 106-3 and the like, as shown in FIG. 4, or different designated devices). The receiver of the transmitted results may not be able to distinguish whether the results of the security function came from the first system or the second system. Thus, the first system may extend support to the second system (including security support) by performing a function (including a security function) instead of, or in addition to, the second system. The first system may use the results of the function in a manner in which the second system may use the results (for example, transmitting the results to a designated device, including the on-premises system and/or local devices 104 associated with the first system)

Referring to FIG. 6, a flow chart of a method 600 of identifying security objects is shown. In one example, the method 600 of identifying security objects may be used in block 502 of FIG. 5. At block 601, the first system may request audit authorization from the second system. In one example, the request to audit the second system can be received by the second system before the second system performs cryptographic transactions (e.g., upon initialization of the second system or at some other designated or un-designated operation time or action of the second system). The audit authorization request can be sent to the second system and/or the manager of the second system (e.g., enclave manager 308). At block 602, the first system may determine whether it has authorization to audit the second system. In some examples, the first system may check memory to determine whether the first system has received authorization to audit the second system at a point in time in the past. In the event the first system does not receive authorization to audit the second system, the first system may resend an authorization request (e.g., block 601) or wait for the second system and/or the manager of the second system to send a subsequent authorization to audit the second system. At block 606, the first system may not audit the second system. In some examples, the first system may be considered to “end” the identification of the security object because the first system may not be presently auditing the second system to identify the security object. Although the first system may be “ending” the identification of the security object, the first system may continue to second subsequent audit authorizations to the second system. In one example, the second system may not approve of audit authorization in the event the second system does not need support with security functionality. In other examples, the second system may not approve of audit authorization in an attempt to reduce the network traffic (e.g., the network may be too busy to support the first system passively auditing the second system).

At block 603, the first system may determine that it has authorization to audit the second system and audit the second system. The audit authorization may be received at the first system from the second system and/or the manager of the second system. The auditing may be performed according to the methods described herein or other suitable audit methods. Thus, the first system may audit one or more (or each) of the transactions occurring at the second system.

At block 604, an audit trigger may be received. The audit trigger can include, but is not limited to the occurrence of a cryptographic transaction at the second system. Non-limiting examples of cryptographic transactions can include security object creation, security object activation, security object destruction, security object archival, machine authentication code generation, message and/or data encryption, and message and/or data decryption.

In one non-limiting example, a security object may include a cryptographic key (for encryption, decryption or both). A key may be created by any suitable manner including, but not limited to, a random number generator or pseudorandom number generator generating a string of integers. A pseudorandom generator may create a random sequence deterministically, such that the random sequence is repeatable. In some arrangements, letters can be randomly or pseudorandomly selected as a key. In alternate arrangements, phrases or words can be randomly or pseudorandomly selected as a key. For example, a random generator or pseudorandom generator can be bounded such that only a certain range of integers may be generated. Further, the bounded range of integers can be mapped to a letter or a phrase. Thus, in the event that the random or pseudorandom generator generates an integer or a sequence of integers, the integer or sequence of integer can be mapped to the letter or phrase. Thus, the random or pseudorandom generator can randomly select a letter or a phrase. The key can be generated in any suitable manner such as, but not limited to generation by a hardware security module or by a trusted third party.

Upon generating a key, the key can be archived in a secure key storage database. Alternatively, the key can be utilized before it is archived. In particular examples, the key can be copied to a backup database in the event the storage database becomes compromised. In one example, the key storage database can become compromised in the event the key storage database equipment fails. Key archival can refer to an offline long-term storage of keys. In some arrangements, archived keys can be deactivated keys that are no longer in use. Alternatively, archived keys can be currently activated keys that are not used often, or a combination of activated and deactivated keys.

Further, a cryptographic transaction may include destroying a security object such as a key. In some examples, a key can be destroyed after it has been archived, as discussed herein. A key can be destroyed at a particular location, for example in a memory. In the event the key is destroyed in a particular location, the key can still be reconstructed (e.g., the key may be destroyed in one memory location but still exist in another location, for example the archived location and/or memory in a remote system). In other examples, all instances and information of the key may be completely removed from all location, making it very difficult to reconstruct the key. (e.g., a remote system may replicate the cryptographic transaction occurring at the local system and destroy the key).

In some examples, cryptographic transactions may include machine authentication code (MAC) generation. A MAC can be information used to authenticate a message. An authenticated message can be a message where the sender of the message's authenticity is validated. In some arrangements, the MAC can be a code generated by a random number generator or a pseudorandom number generator. A code consisting of integers, letters or phrases may be appended to the original message. A receiver can be configured to expect a certain MAC appended to the message. Thus, when the message is sent to the receiver, the receiver checks the sender's MAC. In the event the sender's MAC matches the receiver's expected MAC, then the receiver can determine that the message validly came from the sender. In some arrangements, a key can be used to generate the MAC. For example, a key can be used as an input into a function to generate the MAC. The receiver can use the same key in the same function and generate the same MAC, thus validating the message received.

Cryptographic transactions may occur based on the receipt of one or more pre-defined or identifiable messages. For example, a pre-defined or identifiable message may include a message that requests a security function requiring a cryptographic transaction to occur (for example, a message may request encryption such that the device receiving the request message, the on-premises device and/or enclave, will perform the security function to encrypt the message or other information). In other examples, cryptographic transactions may occur automatically (for example, but not limited to, after a certain amount of time has passed, or after a security object expires or upon occurrence of another designated event) and/or manually (for example, based on a user input).

At block 605, the security object can be replicated at a first system from the second system. In some examples, the first system can be a cloud-based system, (e.g., enclave 106 in FIG. 4 or other cloud-based system). The security object can be replicated (e.g. copied or received) from a second system. In some examples, the second system can be an on-premises system (e.g., local device or other on-premises-device 104 in FIG. 4) associated with the enclave 106 from block 501. Thus, the cryptographic boundaries of both the on-premises systems and cloud-based systems can remain unchanged (i.e., not extending the scope, not compromising security standards, etc.) while the data in the cryptographic boundaries (the security objects) may be replicated in at least two difference systems and/or devices. In some arrangements, the replicated security object may be stored at the first system.

In some examples, the replication of encryption information can occur in real time. The on-premises system does not have to initiate communication with the cloud-based system before the transaction occurs. The replication of security objects can occur in real time because of the received audit trigger in block 604. The audited transaction (e.g., cryptographic transaction) may trigger one or more nodes to replicate the security object from the on-premises system to the cloud-based system.

In some arrangements, a node can be a mechanism for linking the cloud-based system to the on-premises system. For example, nodes can be routers, switches, servers, and the like. Each node linking the cloud-based system to the on-premises system can be active such that the occurrence of one or more audited cryptographic transactions, based on the detected audit triggers, at the on-premises system causes the nodes linked to the cloud-based system to automatically synchronize, replicating the security objects in the audited cryptographic transaction at the on-premises system. In some arrangements, the simultaneous replication of the security object by the nodes can be considered a security feature. For example, an attacker can not inject a false key into the system because each of the nodes can simultaneously be replicating the security object. Thus, in the event of a mismatched key, the majority of the nodes with the true replicated key can prevail over the minority of notes with a mismatched key. Thus, the cloud-based system will receive the true replicated key from the nodes.

The first system may use the replicated security object to perform a security function (for example, as represented by block 503 in FIG. 5). As discussed herein, the replicated security object at the first system may be used to perform a security function in the first system (in the first cryptographic boundary) in place of performing the security function with the original security object in the second system (in the second cryptographic boundary).

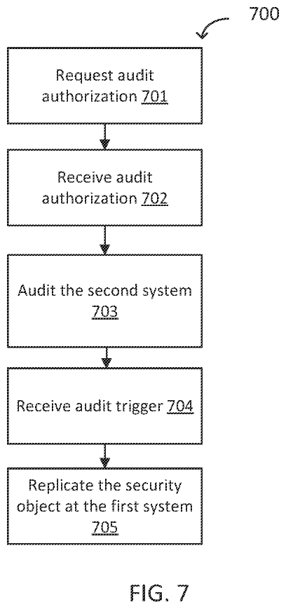

Referring to FIGS. 1-7 the data replication system 700 is an example system of support provided for an on-premises device by an enclave, according to some arrangements. Device 701 can be a device connected to a wide area network such as, but not limited to the Internet (for example, an Internet of Things or IoT device) or a server (or one or more servers) in a database. Device 701 is configured to transmit requests (including cryptographic requests) over one or more networks. In examples where the third system is an IoT device, there can be additional advantages.

Device 701 can send a request including, but not limited to a cryptographic request. A cryptographic request may be request the cloud-based system and/or on-premises system 709 perform a security function. For example, device 701 can request that a message be encrypted. Examples of requests that the third device may transmit include message and/or data encryption, message and/or data decryption, firmware signing, firmware validation, attestation of trust associated with one or more devices, transmittal of authentication codes, or reception of authentication codes.

In some examples, the request from device 701 can include requesting that a message be decrypted. Thus, the cloud based system and/or the on-premises system 709 may receive the message, in the cryptographic request, and decrypt the message using keys or a different decryption method. Subsequently, the cloud-based system and/or the on-premises device 709 that decrypted the message can transmit the decrypted message back to device 701. Both the cloud-based system and the on-premises system 709 can decrypt the message the same way because the cloud-based system and the on-premises system 709 have the same identified security objects (e.g., replicated keys).

In other examples, the request from device 701 can include firmware signing and/or firmware validation. Firmware can be considered a specific class of software that is read only (i.e., generally is not changed by the device). Firmware can be considered software that operates hardware. Firmware signing can be a way of validating firmware such that a receiver knows where the firmware came from. For example, it may be advantageous for a receiver to determine that the firmware came from the vendor. The vendor can “sign” the firmware such that the receiver can determine that the vendor is the sender of the firmware. It may be advantageous for a vendor to send firmware updates to resolve software bugs, for example.

In some examples, a signed firmware can consist of firmware with an appended cryptographic signature, or a hash. While a key or other security object can be predetermined and transmitted between a sender and a receiver, a hash can be a one-way encryption mechanism that must be hashed at both a sender and receiver. Hash is not de-hashed at a receiver as encrypted messages are decrypted by descrambling the scrambled message. Instead, the original message that was hashed can be retrieved by the receiver by applying the same hash function to the same original message.

Firmware can be hashed and a receiver may examine the hash and perform the same hash function to reveal the original message. The ability to reveal the original message establishes trust between the sender and the receiver because the receiver anticipated receiving messages from that sender. In some arrangements, the receiver determining to trust the sender can be considered remote attestation of trust. Thus, the receiver may trust that the sender is who the sender claims to be and/or that the message contains what the message is supposed to contain in the event that the received message contains data that the receiver is expecting or is prepared to operate on.

In other examples, generating trust may include generating MACs. For example, a device 701 may have a specific MAC and the receiver (not shown) may have prior knowledge that the specific MAC is mapped to the specific device 701. Thus, by appending the specific MAC to the device message, the receiver may trust the message and determine that the message came from the specific device 701.

Trust may be generated using the cloud-based system and/or the on-premises system 709. For example, device 701 may send a request that trust be generated for a particular receiving device (not shown) by authenticating a message that the device intends to send to the receiving device. For example, trust may be generated by signing firmware and/or appending expected MACs to the message. Subsequently, the cloud-based system and/or the on-premises system 709 may receive the message, in the request, and modify the message using the security function associated with the request (i.e., signing firmware and/or appending a MAC to the message). Subsequently, the cloud-based system and/or the on-premises system 709 that performed the message authentication can transmit the authenticated message back to the device 701. Both the cloud-based system and the on-premises system 709 can authenticate messages in the same way because the cloud-based system and the on-premises system have replicated security object (such as, but not limited to keys, hash functions, and the like). The authenticated message can allow the receiver to trust the message and/or where the message came from.

In some examples, the requests may involve the same security functions that the first system and the second system are configured to perform. For example, the first system and second system may be configured to encrypt data. Thus, the types of request requested by the third device may include encryption. The request sent by device 701 may be a cryptographic request or other security related request. The request does not need to contain any security object because the cloud-based system has replicated all of the security object that was generated by the on-premises system. The request can be routed through a network or a series of networks 703 via path 702. The request can be routed via path 704 to a domain name server 705 or other routing mechanism.

A domain name server is generally responsible for routing messages across a network. The domain name server, or other routing system, can route the request from the third system to either the cloud-based system or the on-premises system because the two systems have the same information. In some examples, there does not need to be additional logic that routes the requests. This is because wherever the request ends up (i.e., either the on-premises system or the cloud-based system), the request can be responded to. In other examples, the traffic in the network may determine how the domain name server 705 selects the destination of the cryptographic request.

The request may be routed through one or more networks 707 via path 706. A particular cloud-based enclave or on-premises device 709 can receive the cryptographic request via path 708. The particular cloud-based enclave or on-premises device 709 can respond to the request.

The response to the request can be can be based on the security object, the request and the security function used to perform the request. Examples of responses that may be transmitted to the third device may include message and/or data encryption, message and/or data decryption, firmware signing, firmware validation, attestation of trust associated with one or more devices, transmittal of authentication codes, or reception of authentication codes. In some examples, the response may involve the same security functions that the first system and the second system are configured to perform. For example, the first system and second system may be configured to encrypt data. Thus, the types of responses transmitted to the third device may include encryption.

For example, in the event an IoT device 701 sends a cryptographic request that asks for a message to be decrypted, both the cloud-based system and the on-premises system 709 can be capable of decrypting the message and responding to the request because of the security object that was identified at the on-premises system. Thus, the cloud-based system and/or the on-premises system 709 may receive the message, in the cryptographic request, and decrypt the message using keys or other security objects. Subsequently, the response to the cryptographic request can be transmitted through links 710-713 until the response to the cryptographic request reaches the device 701. Both the cloud-based system and the on-premises system 709 can decrypt the message the same way because the cloud-based system and the on-premises system 709 have replicated encryption material.

In some examples, the request can be sent to the on-premises system. Alternatively or in addition, the cryptographic request can be sent to the cloud-based system. Thus, the cryptographic request from the third system can be responded to by either the on-premises system or the cloud-based system. In this manner, the cloud-based system extends support to the on-premises system because either the on-premises system or the cloud-based system is capable of responding to the cryptographic request, even though both the on-premises system and the cloud-based system have their own cryptographic boundaries. In some arrangements, it can be advantageous to keep the on-premises system hidden from the third system.

The various examples illustrated and described are provided merely as examples to illustrate various features of the claims. However, features shown and described with respect to any given example are not necessarily limited to the associated example and can be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, some steps or methods can be performed by circuitry that is specific to a given function.

In some exemplary examples, the functions described can be implemented in hardware, software, firmware, or any combination thereof. If implemented in software, the functions can be stored as one or more instructions or code on a non-transitory computer-readable storage medium or non-transitory processor-readable storage medium. The steps of a method or algorithm disclosed herein can be embodied in a processor-executable software module which can reside on a non-transitory computer-readable or processor-readable storage medium. Non-transitory computer-readable or processor-readable storage media can be any storage media that can be accessed by a computer or a processor. By way of example but not limitation, such non-transitory computer-readable or processor-readable storage media can include RAM, ROM, EEPROM, FLASH memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm can reside as one or any combination or set of codes and/or instructions on a non-transitory processor-readable storage medium and/or computer-readable storage medium, which can be incorporated into a computer program product.

The preceding description of the disclosed examples is provided to enable any person skilled in the art to make or use the present disclosure. Various modifications to these examples will be readily apparent to those skilled in the art, and the generic principles defined herein can be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A method of using security objects across cryptographic boundaries comprising:
associating one or more first systems with one or more second systems, wherein the first system has a first cryptographic boundary and the second system has a second cryptographic boundary;
identifying, at the one or more first systems, one or more security objects on one or more second systems in the second cryptographic boundary;
performing one or more security functions at the one or more first systems using the one or more security objects, the performance of the security function occurring in the first cryptographic boundary; and
transmitting, by the one or more first systems, one or more results based on the performed one or more security functions.

2. The method of claim 1 further comprising:
transmitting, by the one or more first systems to the one or more second systems, an audit request, the audit request being a request to audit one or more cryptographic transactions at the second system; and
receiving, by the one or more first systems from the one or more second systems, an audit approval, the audit approval being approval to audit the one or more cryptographic transactions at the second system.

3. The method of claim 1, wherein identifying the one or more security objects comprises:
auditing, by the one or more first systems at the one or more second systems, one or more cryptographic transactions, the one or more cryptographic transactions occurring in at the second one or more systems in the second cryptographic boundary; and
replicating, at the first one or more systems in the first cryptographic boundary, based on an audit trigger occurring at the second one or more systems in the second cryptographic boundary, the one or more security objects.

4. The method of claim 3 further comprising storing, by the first one or more systems, the replicated security object.

5. The method of claim 3, wherein the one or more cryptographic transactions include key creation, key activation, key destruction, key archival, machine authentication code generation, message encryption, and message decryption

6. The method of claim 3, wherein the security objects includes at least one of key material, policy information, automation information, device data, or audit data.

7. The method of claim 3, wherein the audit trigger is based on the one or more cryptographic transactions.

8. The method of claim 1 further comprising:
receiving, at the first one or more systems, from a third system a cryptographic request; and
transmitting, from the first one or more systems to the third system, a response, the response based on the performance of the one or more security functions using the cryptographic request and the identified one or more security objects.

9. The method of claim 8, wherein the cryptographic request includes at least one of message encryption, message decryption, firmware signing, firmware validation, attestation of trust associated with one or more devices, transmittal of authentication codes, or reception of authentication codes.

10. The method of claim 1, wherein the one or more security functions include at least one of message encryption, message decryption, firmware signing, firmware validation, attestation of trust associated with one or more devices, transmittal of authentication codes, or reception of authentication codes.

11. The method of claim 1, wherein the first one or more systems is one or more cloud-based systems.

12. The method of claim 11, wherein the first one or more systems is a self-sustaining portion of a cloud-based system, the self-sustaining portion of the cloud-based system created from the one or more cloud-based systems.

13. The method of claim 1, wherein the second one or more systems is one or more on premises systems.

14. The method of claim 8, wherein the third system is an Internet of Things device configured to send the cryptographic request.

15. The method of claim 1, wherein the first cryptographic boundary is a first physical bound encompassing a second physical bound of at least one of hardware, software or firmware, the hardware, software or firmware configured for cryptographic purposes.

16. The method of claim 1, wherein the second cryptographic boundary is a first physical bound encompassing a second physical bound of at least one of hardware, software or firmware, the hardware, software or firmware configured for cryptographic purposes.

17. A non-transitory processor-readable medium having processor-readable instructions, when executed, cause a processor to:
associate one or more first systems with one or more second systems, wherein the first system has a first cryptographic boundary and the second system has a second cryptographic boundary;
identify, at the one or more first systems, one or more security objects on one or more second systems in the second cryptographic boundary; and
perform one or more security functions at the one or more first systems using the one or more security objects, the performance of the security function occurring in the first cryptographic boundary.

18. A system for distributing key management information comprising:
a first system with a first cryptographic boundary;
a second system with a second cryptographic boundary; and
a third system;
wherein the first system is configured to:
associate with the second system;
identify one or more security objects on the second system in the second cryptographic boundary; and
perform one or more security functions using the one or more security objects, the performance of the security function occurring in the first cryptographic boundary.

19. The system of claim 17, wherein the identifying the one or more security objects comprises:
auditing, by the one or more first systems at the one or more second systems, one or more cryptographic transactions, the one or more cryptographic transactions including include key creation, key activation, key destruction, key archival, machine authentication code generation, message encryption, and message decryption; and
replicating, at the first one or more systems based on an audit trigger occurring at the one or more second systems, the one or more security objects, the replicated one or more security objects in the first cryptographic boundary.

20. The system of claim 17, wherein the one or more security objects includes at least one of key material, policy information, automation information, device data, or audit data.
